(19) United States
(12) Patent Application Publication
(10) Pub. No.: US 2013/0120836 A1
(43) Pub. Date: May 16, 2013

(54) DIOPTER LENS

(71) Applicant: Pengwei XU, Shenzhen (CN)

(72) Inventor: Pengwei XU, Shenzhen (CN)

(73) Assignee: NVIDIA CORPORATION, Santa Clara, CA (US)

(21) Appl. No.: 13/544,842

(22) Filed: Jul. 9, 2012

(30) Foreign Application Priority Data
Nov. 14, 2011 (CN) 201110357982.6

(51) Int. Cl. G02B 27/22

(52) U.S. Cl. 359/463

(57) ABSTRACT

An embodiment in accordance with the invention relates to a set of stereoscopic glasses comprising no-diopter stereoscopic lenses and at least one diopter lens component. An embodiment in accordance with the invention also relates to a lens component used in the stereoscopic glasses. The stereoscopic glasses of an embodiment in accordance with the invention are convenient for customers who are myopic or need to wear glasses.

### CROSS-REFERENCE TO RELATED APPLICATION

This patent application claims the benefit and priority of the co-pending Chinese Patent Application No. 201110357982.6, by Pengwei XU, filed on Nov. 14, 2011, Attorney Docket Number P2011168, which is hereby incorporated by reference.

### BACKGROUND

Stereoscopic glasses, also called three-dimension glasses, 3D glasses, is a computer device used for watching a stereoscopic game scene, stereoscopic movies, and simulation results. The early stereoscopic glasses were color filter glasses. The stereoscopic imaging technology (called Complementary Color Anaglyphs) at that time worked by using a filter to block certain colors from each eye. The most commonly seen glasses utilize a red and cyan lens to pass red to one eye and blue and green to the other. With the development of the stereoscopic imaging technology, polarized stereoscopic glasses emerge, which is mainly used in theaters and other advanced applications. Both of the polarized stereoscopic glasses and the color filter glasses deliver slightly different images to each eye by a filter. The polarized stereoscopic glasses include two glasses with different polarization directions so that two separate images can be projected, respectively.

As the stereoscopic imaging technology has gradually extended to the areas of home television sets and household display, the active shutter glasses became popular. The most common display modes of active shutter glasses are the following: Interlacing, Page-Flipping, Line-Blanking, and Sync-Doubling.

Although the stereoscopic glasses have been developed for many years, people rarely consider solving the problem for myopic people who have to support two pairs of glasses on their nose to watch stereo images. As the structure of stereoscopic glasses is more and more complicated, the inconvenience of wearing two pairs of glasses is increasingly significant. Besides, as the stereoscopic imaging technology is being introduced to mainstream consumers and PC (personal computer) gamers, watching stereo images is becoming a part of daily life.

### SUMMARY

Accordingly, there is thus a need for stereoscopic glasses that are convenient for customers who are myopic or need to wear glasses.

Various embodiments in accordance with the invention provide a set of stereoscopic glasses and a lens component used therein.

An embodiment in accordance with the invention provides a set of stereoscopic glasses comprising no-diopter stereoscopic lenses and at least one diopter lens component.

In various embodiments, with respect to the “stereoscopic lenses”, although such an item is referred to herein as lenses, this is not intended to signify that they would necessarily include optically refractive means. In various embodiments, they can include the same type of optical filters known in the art.

In an embodiment, the main body of the lens component is a reflective lens which is chosen according to a customer's diopter. In order to be combined with a stereoscopic lens, for convenience, one side of the lens component may be dioptric surface, while the other may be non-dioptric surface. In one embodiment, the dioptric surface lies on the side close to the eyes. The lens component may also have a dioptric surface on both sides.

Considered from the perspective of industrial design, in an embodiment, the lens component may be fixed (or attached or coupled) adjacent to a stereoscopic lens on the side close to the eyes. In an embodiment, the lens component may also be fixed (or attached or coupled) adjacent to a stereoscopic lens on the side distant from the eyes.

In an embodiment, the lens component comprises a structure for combining the lens component with a stereoscopic lens, and the structure can be selected from a fixing unit, machinery fittings, clamping fittings, attaching element, magnetic fittings, or a combination thereof. Considering the structure of general stereoscopic glasses, in one embodiment, the structure for combining may be arranged on at least one of the upper and the lower parts of the lens component.

Alternatively, in an embodiment, the stereoscopic glasses further comprise a frame having a structure for combining the stereoscopic lenses with at least one lens component. The structure may be selected from a fixing unit, machinery fittings, clamping fittings, attaching element, magnetic fittings, or a combination thereof.

In one embodiment, the lens component is separate, which is convenient for customers to choose and change according to demand.

An embodiment in accordance with the invention provides a lens component used for the aforesaid stereoscopic glasses.

Additional features and advantages of various embodiments in accordance with the invention will be set forth in the description that follows, and in part will be apparent from the description, or may be learned by practice of various embodiments of the invention. The advantages of the various embodiments of the invention will be realized and attained by the structure particularly pointed out in the written description and claims hereof as well as the appended drawings.

It is to be understood that both the foregoing general description and the following detailed description are exemplary and explanatory and are intended to provide further explanation of various embodiments of the invention as claimed.

While particular embodiments in accordance with the invention have been specifically described within this Summary, it is noted that the invention and the claimed subject matter are not limited in any way by these embodiments.

### BRIEF DESCRIPTION OF THE DRAWINGS

The accompanying drawings are included to provide a further understanding of various embodiments in accordance with the invention, and are incorporated in and constitute a part of this specification. The drawings illustrate various embodiments of the invention and, together with the description, serve to explain principles of various embodiments in accordance with the invention. In the drawings,

FIG. 1 is a plan view of a lens component in accordance with an embodiment of the invention.

FIG. 2 is a sectional view of the lens component as shown in FIG. 1 in accordance with an embodiment of the invention.

FIG. 3 is a schematic view of a set of stereoscopic glasses in accordance with an embodiment of the invention.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details or with equivalents thereof. In other instances, well known methods, procedures, components, and circuits have not been described in detail as not to unnecessarily obscure aspects of the invention.

Various example embodiments are described herein in the context of stereoscopic glasses with diopter lens components and the diopter lens component used therein. Those of ordinary skill in the art will realize that the following description is illustrative only and is not intended to be in any way limiting. Other embodiments will readily suggest themselves to those skilled in the art having the benefit of this disclosure. Reference will now be made in detail to implementations of the example embodiments as illustrated in the accompanying drawings. The same reference indicators will be used to the extent possible throughout the drawings and the following description to refer to the same or like items.

Various embodiments in accordance with the invention relate to stereoscopic glasses, especially the stereoscopic eyeglasses with diopter lens components, which are convenient for customers who are myopic or need to wear glasses. Various embodiments in accordance with the invention also relate to a lens component used for the stereoscopic glasses.

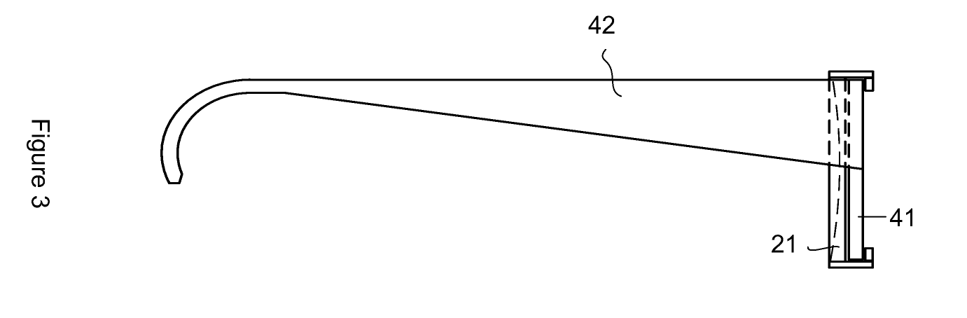

Within FIG. 3, the stereoscopic glasses in accordance with an embodiment of the invention comprises a frame 42 and a stereoscopic lens 41. The frame 42 comprises a rim and temple arms. In some embodiments, the rim and temple arms are unity. According to various kinds of stereoscopic glasses in accordance with various embodiments, power supply and 3D function device (for example, infrared receivers, etc.) may be provided or included.

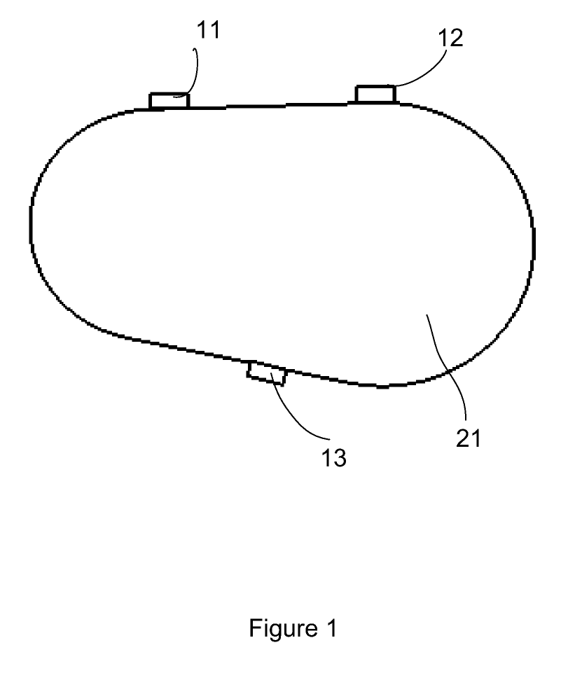

As shown in FIG. 1, in an embodiment, the lens component comprises a refractive lens 21 and fixing units 11, 12, and 13 as a structure for combining the lens component with a stereoscopic lens. As shown in FIG. 3, in an embodiment, the refractive lens 21 is fixed (or attached or coupled) on a stereoscopic lens 41 with fixing units.

The stereoscopic lens in accordance with various embodiments of the invention can be various stereoscopic lenses including, but not limited to, those used in color filter glasses, polarized 3D glasses, and active shutter glasses.

Within various embodiments, there is no special restriction upon the number and type of the fixing units, provided that the structure can combine the lens components with the stereoscopic lens. In addition to fixing unit, the structures of similar functions include, but not limited to, machinery fittings, clamping fittings, attaching elements, magnetic fittings, or a combination thereof. According to the shapes of the stereoscopic glasses in various embodiments, one or more fixing units may be used, either arranged on the upper or the lower parts of the rim, or both. In some embodiments, they can also be arranged on two lateral sides of the lens.

According to another embodiment, the fixing unit is a clamp arranged above the lens components. In order to avoid scratching the lens, the front of the clip uses flexible materials.

According to another embodiment, two lens components are connected together through a bridge.

Alternatively, according to one embodiment, the fixing unit for combining the lens component with the stereoscopic lens is arranged on the frame of the stereoscopic glasses. In this embodiment, the lens component does not necessarily comprise a fixing unit. Moreover, based on the fixing units used in the frame, the lens components may comprise structures corresponding to the frame. There is no restriction upon position of the fixing units, either on at least one of the upper and the lower parts of the frame, or on two lateral sides, or other suitable positions.

Alternatively, according to an embodiment, the two lens components are connected together through a bridge, with two projections formed respectively on two lateral sides of the frame. In order to match the projections to fasten (or attach or couple) the lens components, two knees are formed at the outer parts of the two lens component, respectively. In an embodiment, the knee can be made of flexible materials, for instance, elastomer and fabric, etc.

In an embodiment, for the convenience of the combination of diopters, the lens components can be separate (detachable). However, in some embodiments, the two lens components may also be connected through a detachable bridge, provided that there is no adverse influence on the convenience of the combination. Various embodiments include the combinations of no-diopter stereoscopic lens and diopter lens, and of different separate diopter lenses.

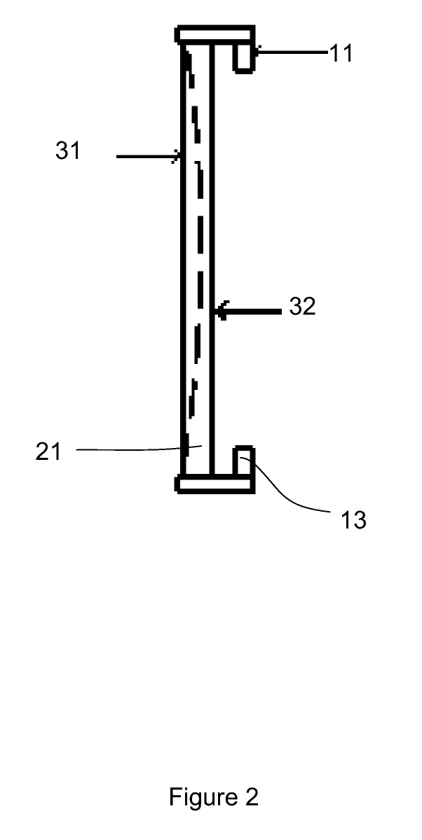

FIG. 2 shows a sectional view of the lens component as shown in FIG. 1 in accordance with an embodiment of the invention. In an embodiment, the dioptric surface 31 of the lens component 21 is arranged on the side close to the eyes while the non-dioptric surface 32 is close to the inner stereoscopic lens (not shown).

Although there is no restriction upon the position of the lens component and the stereoscopic lens, based on numerous experiments, in an embodiment the lens component is arranged adjacent to a stereoscopic lens on the side close to the eyes, in view of the convenience for optical path design of the lens components, comfort for wearing, and beautiful appearance. However, in some embodiments, the lens component may also be arranged outside a stereoscopic lens, namely on the side distant from the eyes.

In various embodiments, the dioptric surface of the lens component can be designed with various diopter according to customers' demand. The methods for providing the lens components with a desirable diopter are known in the art.

In various embodiments, the shape of the lens component is not limited, such as circular, ellipse, parabola-shape or rectangular, etc. In various embodiments, the size of the lens components can be chosen according to the situation without certain restriction. In various embodiments, it is consistent with, and not smaller than the size of the stereoscopic lens.

In an embodiment, according to demand, the lens component may also comprise coatings, for instance, a hardening film, an anti-reflection film, a waterproof film, a radioprotective film, a polarizing film, anti-fog film, and splitting film, etc. In an embodiment, any desirable coating may be applied to the lens, provided that it does not influence watching stereo images.

In various embodiments, there is no special restriction regarding the materials of the lens component. Common materials such as resin, glass, etc. are all available. Considering the weight, resin may be desirable in an embodiment.

In accordance with various embodiments of the invention, it is not necessary for the stereoscopic glasses to have a frame.

To sum up, various embodiments in accordance with the invention provide a set of stereoscopic glasses that are convenient for customers wearing glasses, wherein the stereoscopic lens is combined with a separate lens component for each eye. In an embodiment, customers can choose a suitable lens component for each eye to match their demand, and the lens component can be fastened (or attached or coupled) separately on the stereoscopic glasses, such as NVIDIA 3D Vision glasses. Thereby, it enables customers to avoid supporting two glasses on their nose and optimizes their 3D experience with 3D version. Moreover, various embodiments in accordance with the invention are also advantageous to be used in a public theater or cinema. In an embodiment, it can be simply and easily combined on the spot according to customers' different demands.

It should be appreciated that various modifications, adaptations, and alternative embodiments thereof may be made within the scope and spirit of the invention. The invention is further defined by the following Claims.

The foregoing descriptions of various specific embodiments in accordance with the invention have been presented for purposes of illustration and description. They are not intended to be exhaustive or to limit the invention to the precise forms disclosed, and many modifications and variations are possible in light of the above teaching. The invention is to be construed according to the Claims and their equivalents.

What is claimed is:

1. A set of stereoscopic glasses comprising:
no-diopter stereoscopic lenses; and
at least one diopter lens component.

2. The set of stereoscopic glasses of claim 1, wherein a first side of said at least one diopter lens component is a dioptric surface while a second side is a non-dioptric surface.

3. The set of stereoscopic glasses of claim 1, wherein said at least one diopter lens component comprises two dioptric surfaces.

4. The set of stereoscopic glasses of claim 1, wherein said set of stereoscopic glasses are selected from color filter glasses, polarized three-dimension glasses, and active shutter glasses.

5. The set of stereoscopic glasses of claim 1, wherein said at least one diopter lens component is coupled adjacent to one of said no-diopter stereoscopic lenses.

6. The set of stereoscopic glasses of claim 1, wherein said at least one diopter lens component comprises a structure for combining with one of said no-diopter stereoscopic lenses.

7. The set of stereoscopic glasses of claim 1, further comprising a frame comprising a structure for combining said no-diopter stereoscopic lenses with said at least one diopter lens component.

8. The set of stereoscopic glasses of claim 1, wherein said at least one diopter lens component is detachable.

9. A set of stereoscopic glasses comprising:
no-diopter stereoscopic lenses;
a frame comprising said no-diopter stereoscopic lenses; and
a diopter lens component.

10. The set of stereoscopic glasses of claim 9, wherein said diopter lens component is fixed adjacent to one of said no-diopter stereoscopic lenses.

11. The set of stereoscopic glasses of claim 9, wherein a first side of said diopter lens component is a dioptric surface while a second side is a non-dioptric surface.

12. The set of stereoscopic glasses of claim 9, wherein said diopter lens component comprises two dioptric surfaces.

13. The set of stereoscopic glasses of claim 9, wherein said diopter lens component is detachable.

14. The set of stereoscopic glasses of claim 9, wherein said diopter lens component comprises a structure for combining with one of said no-diopter stereoscopic lenses.

15. The set of stereoscopic glasses of claim 9, wherein said set of stereoscopic glasses are selected from color filter glasses, polarized three-dimension glasses, and active shutter glasses.

16. A diopter lens component comprising:
a structure for combining with a stereoscopic lens of a set of stereoscopic glasses.

17. The diopter lens component of claim 16, wherein a first side of said diopter lens component is a dioptric surface and a second side is a non-dioptric surface.

18. The diopter lens component of claim 16, wherein said diopter lens component comprising two dioptric surfaces.

19. The diopter lens component of claim 16, wherein said structure is selected from a fixing unit, machinery fitting, clamping fitting, attaching element, or magnetic fitting.

20. The diopter lens component of claim 19, wherein said diopter lens component is coupled adjacent to said stereoscopic lens.
